(19) United States
(12) Patent Application Publication
(10) Pub. No.: US 2026/0009270 A1
(43) Pub. Date: Jan. 8, 2026

(54) MONITORING DEVICE FOR A DOOR FUNCTIONAL UNIT

(71) Applicant: dormakaba Deutschland GmbH, Ennepetal (DE)

(72) Inventors: Michael THIELE, Ennepetal (DE); Alexander HELLWIG, Ennepetal (DE)

(21) Appl. No.: 19/254,521

(22) Filed: Jun. 30, 2025

(30) Foreign Application Priority Data
Jul. 2, 2024 (EP) 24186002.2

(51) Int. Cl. E05F 1/10

(52) U.S. Cl. CPC E05F 1/10; E05Y 2201/46; E05Y 2400/322

(57) ABSTRACT

A monitoring device for a door functional unit, in particular a door closer, door drive, door lock or door hold-open system, including a sensor unit, designed for arrangement in the door functional unit, having a first magnetic sensor and an associated encoder, with the sensor unit being designed and configured to detect a position of a moving functional element of the door functional unit, and at least one second magnetic sensor which is designed and configured to detect an external magnetic field to monitor the operation of the first magnetic sensor.

### CROSS-REFERENCE TO RELATED APPLICATIONS

This application claims the benefit of European patent application no. 24186002.2, filed on 2 Jul. 2024, the disclosure of which is incorporated herein by reference in its entirety.

### TECHNICAL FIELD

The disclosure relates to a monitoring device for a door functional unit. The door functional unit is, for example, a door closer, a door drive, a door lock or a door hold-open system.

### BACKGROUND

EP 3 315 704 A1 shows a system for monitoring safety-relevant functions of a door closer. A combination of position and acceleration signals is used to verify whether the door closer has been broken or tampered with. For example, it is possible to identify whether a lever connected to the output shaft of the door closer has been unhooked.

### SUMMARY

The present disclosure provides a monitoring device for a door functional unit which enables safe use of a door by simple means, in particular simple manufacture and low-maintenance operation.

The advantage is achieved by providing the features of the independent claim. The dependent claims relate to preferred configurations of the disclosure.

The disclosure shows a monitoring device for a door functional unit. The door functional unit is, in particular, a door closer, a door drive, a door lock or a door hold-open system.

The monitoring device comprises a sensor unit. The sensor unit is designed for arrangement in the door functional unit. The sensor unit comprises a first magnetic sensor and an associated encoder. The sensor unit is designed and configured to detect a position of a moving functional element of the door functional unit. The encoder is in particular arranged or designed on the functional element for this purpose. As will be described in detail, the door functional unit can, for example, be a door closer, with the encoder being designed or arranged on the output shaft of the door closer. Regardless of how the door functional unit is actually designed, it is preferably provided that the encoder is a separate component that is arranged, in particular fastened, to the functional element. Alternatively, the functional element or a region of the functional element can also be designed in such manner that the functional element itself or the correspondingly designed region acts as an encoder. The encoder is preferably a permanent magnet.

The first magnetic sensor is preferably designed and arranged for identifying the encoder, in particular without contact. The first magnetic sensor is particularly preferably designed to detect a position and/or a rotation and/or an acceleration of the encoder.

The sensor unit can therefore be used to detect how the functional element of the door functional unit moves and/or in which position the functional element is located. This makes it possible to monitor the proper functioning of the door functional unit. As part of the disclosure, it has been recognised that the first magnetic sensor of the sensor unit can be intentionally or unintentionally influenced, in particular disrupted, by external magnetic fields. The first magnetic sensor is intentionally influenced, in particular by manipulation, for example by attaching a correspondingly strong magnet in the immediate vicinity of the door functional unit. In the context of the present explanations, such a magnetic field is referred to as a “manipulative external magnetic field”. In addition, it is also possible that a magnetic field is temporarily or permanently present near the installation location of the door functional unit, for example due to a lift passing near the door functional unit or due to electrical cables. Magnetic fields generated in this way are referred to here as “non-manipulative magnetic fields”.

In the context of the disclosure, it is provided that the monitoring device comprises at least one second magnetic sensor. The at least one second magnetic sensor is designed and configured to monitor the operation of the first magnetic sensor, with an external magnetic field being able to be detected by means of the second magnetic sensor for this purpose. Thus, according to the disclosure, taking into account the signals at the at least one second magnetic sensor, it is possible to identify whether an external magnetic field is present and, in particular, which characteristics, for example which time course or which strength, such an external magnetic field has. Based on this, a conclusion can be drawn as to whether it is a manipulative magnetic field or a non-manipulative external magnetic field, for example. Furthermore, the information recorded by means of the second magnetic sensor can be used to decide whether the external magnetic field has a correspondingly disruptive influence on the sensor unit.

It is preferably provided that the at least one second magnetic sensor is designed for arrangement in the door functional unit. The monitoring device particularly preferably comprises the door functional unit. It is in particular provided that the sensor unit and/or the at least one second magnetic sensor is/are arranged in the door functional unit.

It is preferably provided that the door functional unit comprises a covering and/or a carrier. The covering can, for example, be the covering on a door closer. The carrier can, for example, be a mounting plate. The first magnetic sensor and/or the at least one second magnetic sensor is/are preferably arranged under the covering and/or located on the carrier.

A permanent magnet is preferably located on the covering. This has the advantage that the permanent magnet arranged on the covering can be used to detect whether the covering is being moved relative to the first magnetic sensor and/or relative to the at least one second magnetic sensor. If the covering is removed, for example by manipulating the door functional units, the permanent magnet arranged on the covering moves relative to the first magnetic sensor and/or relative to the at least one second magnetic sensor, which can be identified on the basis of the signals of the magnetic sensors. This allows, for example, a corresponding message or alarm to be output.

It is preferably provided that the monitoring device comprises a circuit board. The circuit board is located in particular in or on the door functional unit. The circuit board is located in particular under the covering described. It is preferably provided that the first magnetic sensor and the at least one second magnetic sensor are arranged on the circuit board.

The monitoring device preferably comprises two of the second magnetic sensors described. The two second magnetic sensors are located on different sides of the first magnetic sensor. This results in redundancy, for example if one of the second magnetic sensors fails. In addition, this arrangement can be used to detect on which side the external magnetic field is located or from which side the external magnetic field acts on the first magnetic sensor.

According to a first variant, it is preferably provided that the at least one second magnetic sensor, in particular all second magnetic sensors, is/are arranged in a region of influence of the sensor unit. According to an alternative definition, it is provided that the distance between the encoder of the sensor unit and the nearest second magnetic sensor is at most 5 cm, preferably at most 3 cm. In this arrangement, the at least one second magnetic sensor is influenced by the encoder of the sensor unit. This influencing of the signals at the at least one second magnetic sensor by the encoder can be taken into account in the corresponding control arrangement such that the external magnetic field can be identified despite this influencing. In addition, this relatively close arrangement of the magnetic sensors to each other has the advantage that the at least one second magnetic sensor can redundantly replace or supplement the first magnetic sensor. Since the signals at the at least one second magnetic sensor are influenced by the encoder, it is also possible to use the signals at the at least one second magnetic sensor to detect the position, speed or movement of the encoder.

According to a second variant, it is preferably provided that the at least one second magnetic sensor, in particular all second magnetic sensors, are located outside a region of influence of the sensor unit. In an alternative definition, it is provided that the distance between the encoder and the nearest second magnetic sensor is at least 6 cm, preferably at least 8 cm. In this situation, the at least one second magnetic sensor is not influenced by the encoder, or only in an irrelevant way, whereby the signals resulting at the second magnetic sensor can be clearly assigned to an external magnetic field.

The following designs are preferably provided for the precise configuration of the first magnetic sensor and/or the at least one second magnetic sensor: The respective magnetic sensor is preferably a Hall sensor or an inductive sensor or a reed switch. Furthermore, it is provided that at least one of the magnetic sensors is designed in such manner that its function is based on the magnetoresistance effect.

Due to its relatively simple configuration, the reed switch can indicate whether a magnetic field, for example an external magnetic field, is present or not. The exact characteristics of the magnetic field cannot be determined, but this is not absolutely necessary. If, for example, a reed switch is used as a second magnetic sensor, this reed switch can indicate whether or not a corresponding external magnetic field of the appropriate strength is present. In principle, this may be sufficient to decide whether or not the sensor unit is expected to operate properly. In addition, the optional permanent magnet on the covering can be detected relatively easily with the reed switch. If the covering with the permanent magnet is removed, the reed switch can detect this and, for example, output a corresponding message.

As mentioned at the beginning, the door functional unit of the monitoring device is preferably designed as a door closer. The door functional unit comprises a housing and an output shaft supported therein as a functional element. In the housing is also located a mechanical energy accumulator that drives the output shaft to rotate, in particular in the closing direction of the door. The energy accumulator is preferably designed as a spring. The encoder of the sensor unit is located on the output shaft or is designed accordingly on the output shaft. The sensor unit is designed to detect an actual angle of rotation of the output shaft. The output shaft is rotatable about an axis of rotation.

The output shaft of the door functional unit, which is designed as a door closer, is designed in particular for fastening a lever arrangement. According to a first mounting variant, the door closer can be fastened on the door, i.e. in particular to the door leaf. The lever arrangement forms the connection to the wall. For example, a slide rail of the lever arrangement is fastened to the wall. According to a second mounting variant, the door closer can be fastened to the wall. The lever arrangement then forms the connection between the door closer and the door leaf. For example, the slide rail of the lever arrangement is fastened on the door leaf. The term “wall” here also includes the door frame.

The spring of the energy accumulator is in particular a coil spring. The energy accumulator is arranged in the housing and drives the output shaft to rotate in a closing direction of rotation.

The output shaft rotates in the closing direction of rotation, in particular when the door closer is properly installed to close a door and the door closes. When the door is opened, the output shaft rotates in the opposite direction, also known as the opening direction of rotation. The door closer is preferably designed without a drive such that it is not in particular a motor-driven door drive. However, as described at the beginning, the door functional unit can also be designed as a door drive. As with the door closer, in the case of the door drive, an output shaft is provided which is connected to the slide rail, for example, via a lever arrangement. However, the output shaft within the door drive is moved in both directions of rotation, for example electronically or hydraulically. The encoder can, for example, also be located on the output shaft in the case of the door drive in order to detect the rotational movement of the output shaft. The sensor unit, in particular on the door closer, makes it possible to detect the position and/or movement of the output shaft by simple means. This allows conclusions to be drawn about the proper functioning of the door closer, whereby the door can be operated safely. For example, it is possible to identify whether the door is open or closed. It is also possible to identify whether the lever arrangement is damaged or has been tampered with.

When the door functional unit is configured as a door closer, it is preferably provided that the first magnetic sensor is positioned at the end face of the output shaft. The axis of rotation of the output shaft preferably intersects the first magnetic sensor and/or the encoder.

As mentioned at the beginning, the door functional unit can also be designed as a door hold-open system or door lock. A door hold-open system is located in the slide rail, for example, and holds the lever arrangement in a certain position, in particular in the open position. In the door hold-open system there are moving elements, referred to here as functional elements, whose position and/or movement can be detected by means of the sensor unit described. If the door functional unit is configured as a door lock, it is also readily apparent that there are moving parts present in the door lock, for example a latch or a bolt, whose movement and/or position can be detected by means of the sensor unit described. In both variants, both in the door hold-open system and in the door lock, an external magnetic field can be detected by means of the at least one second magnetic sensor described here, whereupon corresponding conclusions can be drawn about the proper operation of the sensor unit.

The monitoring device preferably comprises a control arrangement. The control arrangement can basically consist of one or a plurality of control units or differently designed computing units. The control unit can be fully integrated into the door functional unit. However, it is also provided that the control arrangement is arranged partially or completely outside the door functional unit, for example near the door, in a building control centre or in a cloud. If the control arrangement is distributed over a plurality of control units and/or differently designed computing units, these are preferably networked with each other for data exchange.

In order to monitor the operation of the first magnetic sensor by means of the control arrangement, the control arrangement is designed in particular to do the following:

The control arrangement is designed to validate at least one value based on the detected position of the functional element with the first magnetic sensor, with the validation being based on the recorded values of the at least one second magnetic sensor. During the “validation” by means of the control arrangement, it is in particular decided whether the signals of the first magnetic sensor, i.e. the detected position of the functional element, are correct or incorrect. For this purpose, validation is carried out based on the recorded values of the at least one second magnetic sensor. The second magnetic sensor is in particular used to detect and evaluate the external magnetic field.

Additionally or alternatively, the control arrangement is designed to check whether the sensor unit has been manipulated by an external magnetic field, with the check being based on the recorded values of the at least one magnetic sensor. As part of the “checking” process, it is taken into account that not every external magnetic field results due to manipulation. For example, electrical lines or lifts passing nearby can influence the magnetic field, which should be categorised as “non-manipulative” in the present case. However, a magnet deliberately brought near the door functional unit can also result in a “manipulative external magnetic field”. Depending on whether a non-manipulative or manipulative external magnetic field is present, different further steps may need to be initiated, for example verifying the door functional unit or triggering an alarm.

Furthermore, it is preferably provided that the control arrangement is designed to record and store basic state data. This basic state data is based on the signals of the first magnetic sensor and/or the at least one second magnetic sensor without an external magnetic field. The basic state data is thus recorded during a state in which it is ensured that no external magnetic field is present. The basic state data can be used in the control arrangement to identify and characterise detected external magnetic fields. For example, when evaluating the signals of the at least one second magnetic sensor, it is possible to take into account which portions of the signals cannot be assigned to an external magnetic field based on the basic state data.

The control arrangement is preferably designed to store and/or retrieve external magnetic field comparison data sets. “Retrieve” in particular means that these data sets do not have to be stored in the control arrangement itself but can be retrieved from a unit networked with the control arrangement, for example an external memory. The external magnetic field comparison data sets preferably contain data on the duration and/or strength and/or pattern of external magnetic fields.

Furthermore, it is preferably provided that the control arrangement is designed to categorise the detected external magnetic field into disruptive external magnetic fields and non-disruptive external magnetic fields. This categorisation is based in particular on the external magnetic field comparison data sets. The validation described is then based on the categorisation into disruptive/non-disruptive external magnetic fields. For example, it can be taken into account that, on the one hand, an external magnetic field is identified but, on the other hand, this external magnetic field has no or no serious disruptive influence on the sensor unit. If an external magnetic field is classified as a non-disruptive magnetic field, the signals of the sensor unit can still be relied upon, for example. If, on the other hand, it is a disruptive magnetic field, it must be taken into account that the position of the functional element detected with the sensor unit may not be correct.

Furthermore, the control arrangement is preferably designed to categorise the detected external magnetic field into manipulative external magnetic fields and non-manipulative external magnetic fields. This categorisation is also preferably based on the external magnetic field comparison data sets. The described check is then based on the categorisation into manipulative/non-manipulative external magnetic fields.

The described validation and check or the consideration of at least four categories (disruptive/non-disruptive external magnetic and fields manipulative/non-manipulative external magnetic fields) has the following advantage: regardless of whether an external magnetic field is manipulative or non-manipulative, this external magnetic field can be disruptive or non-disruptive. If it is a non-disruptive external magnetic field, the control arrangement can continue to rely on the signals of the sensor unit, which is not the case with disruptive external magnetic fields. Regardless of whether the external magnetic field is disruptive or non-disruptive, it may be a manipulative external magnetic field. In the case of a manipulative external magnetic field, further steps, such as triggering an alarm or checking the immediate vicinity of the door functional unit, may need to be carried out.

The external magnetic field comparison data sets can be generated in different ways. For example, it is possible to define these data sets in advance for certain locations where the door functional unit is used or for the door functional unit per se and make them available to the control arrangement accordingly. For example, the external magnetic field comparison data sets can, in this way, take into account that if a very strong and permanently persistent external magnetic field is present, the probability is relatively high that a permanent magnet has been placed in the door functional unit in a manipulative manner.

As part of the disclosure, however, it is also preferably provided that the control arrangement is designed to do the following in a learning mode: first, an external magnetic field is detected by means of the at least one magnetic sensor to generate external magnetic field comparison data sets. For example, a strong permanent magnet is placed near the door functional unit to simulate a manipulative external magnetic field. On the other hand, an electrical line located nearby, for example, can also be activated accordingly in order to simulate a possibly disruptive but non-manipulative external magnetic field.

In the next step, the learning mode provides that a categorisation of the detected external magnetic field is retrieved. For example, a person, a database or an artificial intelligence is queried as to whether the external magnetic field that has just been detected is a disruptive or non-disruptive magnetic field and/or it is queried whether it is a manipulative or non-manipulative external magnetic field.

In the next step, the external magnetic field comparison data set with the corresponding categorisation is saved.

The control arrangement is also designed to output a corresponding signal to another arrangement, with the signal being based on the result of the validation described and/or on the result of the check described. The “other arrangement” can be any technical unit that is connected to the control arrangement for data exchange. For example, the other arrangement is a building control centre, a loudspeaker, a visual display, a cloud server or, for example, a mobile phone.

Furthermore, the control arrangement is preferably designed to output a message that can be perceived by a person, with the message being based on the result of the validation and/or on the result of the check. The control arrangement can thus comprise corresponding means for outputting such a message, for example the control arrangement can comprise a loudspeaker and/or visual output means.

In addition, the control arrangement is preferably designed to save a value in a memory, with the stored value being based on the result of the validation and/or the result of the check. In this way, the validation and/or check can be logged, for example.

The first magnetic sensor and the at least one second magnetic sensor are preferably arranged to detect the encoder, with the control arrangement being designed to take into account the recorded values of the first magnetic sensor during the validation and/or check, in particular to subtract them at least partially from the recorded values of the at least one second magnetic sensor. This is in particular of interest if the at least one second magnetic sensor is located in the region of influence of the encoder. In this way, the influence of the encoder on the at least one second magnetic sensor can be taken into account by using the signals of the first magnetic sensor for this purpose.

The present disclosure further discloses a method for monitoring a door functional unit. The method is in particular designed to operate the monitoring device defined above and in the claims.

Disclosed is in particular a method for operating the monitoring device described, comprising at least the following steps: Detecting the position of the moving functional element of the door functional unit with the sensor unit; and detecting the external magnetic field with the at least one second magnetic sensor for monitoring the operation of the first magnetic sensor.

The method preferably comprises the following steps, which are carried out by means of the control arrangement: Validating at least one value based on the detected position of the functional element with the first magnetic sensor, with the validation being based on the recorded values of the at least one second magnetic sensor; and/or checking whether the sensor unit has been manipulated by an external magnetic field, with the check being based on the recorded values of the at least one second magnetic sensor; and preferably storing basic state data based on signals of the first magnetic sensor and/or the at least one second magnetic sensor without an external magnetic field.

The method preferably comprises the following steps, which are carried out by means of the control arrangement: Storing and/or retrieving external magnetic field comparison data sets, categorising the detected external magnetic field based on the external magnetic field comparison data sets into disruptive external magnetic fields and non-disruptive external magnetic fields, with the subsequent validation being based on the categorisation into disruptive/non-disruptive external magnetic fields, and/or categorising the detected external magnetic field based on the external magnetic field comparison data sets into manipulative external magnetic fields and non-manipulative external magnetic fields, with the subsequent check being based on the categorisation into manipulative/non-manipulative external magnetic fields.

The method preferably comprises the following steps, which are carried out by means of the control arrangement: Detecting an external magnetic field by means of the at least one second magnetic sensor to generate external magnetic field comparison data sets, retrieving a categorisation of the detected external magnetic field into disruptive/non-disruptive external magnetic fields and/or into manipulative/non-manipulative external magnetic fields, and saving the external magnetic field comparison data set with associated categorisation.

The method preferably comprises the following steps, which are carried out by means of the control arrangement: Outputting a signal to another arrangement, with the signal being based on the result of the validation and/or on the result of the check, and/or outputting a message that can be perceived by a person, with the message being based on the result of the validation and/or on the result of the check, and/or storing a value in a memory, with the stored value being based on the result of the validation and/or on the result of the check.

The method preferably comprises the following steps, which are carried out by means of the control arrangement, with the first magnetic sensor and the at least one second magnetic sensor being arranged to detect the encoder: during the validation and/or check, the recorded values of the first magnetic sensor are taken into account, in particular at least partially subtracted from the recorded values of the at least one second magnetic sensor.

### BRIEF DESCRIPTION OF THE DRAWINGS

The disclosure will now be described in more detail on the basis of an exemplary embodiment, for which is shown:

FIG. 1 a schematic view of a monitoring device according to the disclosure in accordance with an exemplary embodiment,

FIG. 2 a view of a closed door functional unit, designed as a door closer, of the monitoring device according to the disclosure in accordance with the exemplary embodiment,

FIG. 3 an exploded view of FIG. 2,

FIG. 4 the door functional unit represented in FIGS. 2 and 3 without covering and

FIG. 5 the section A-A marked in FIG. 2.

### DETAILED DESCRIPTION OF THE DRAWINGS

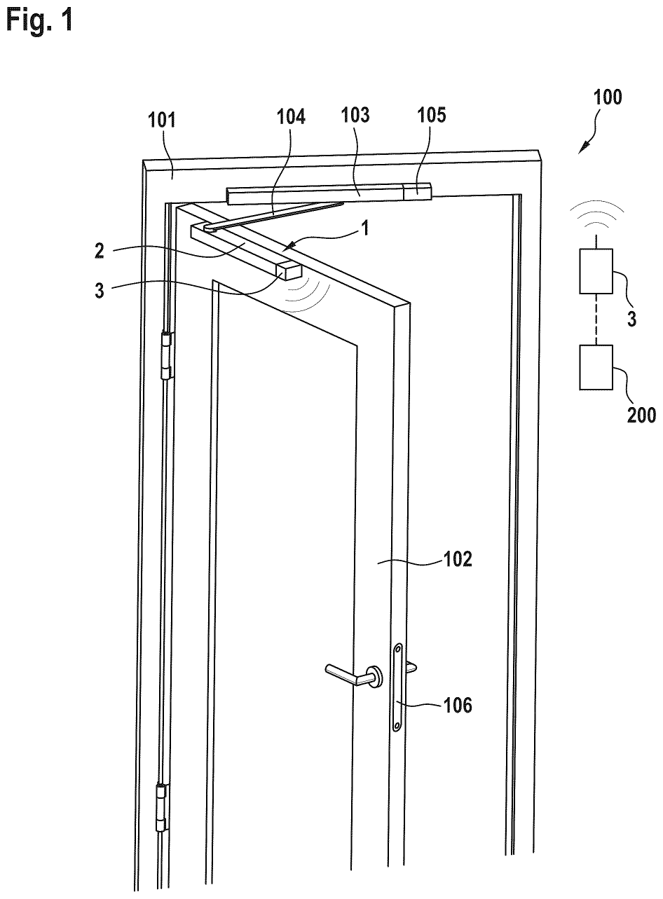

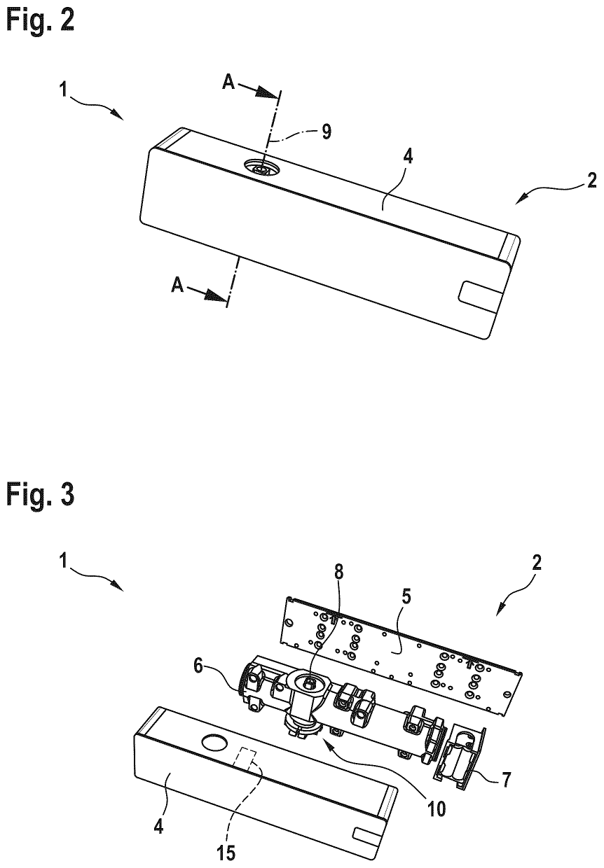

FIG. 1 shows a door 100 with a door frame 101 in which a door leaf 102 of a swing door is located. A door closer 2 is located on the door leaf 102. A slide rail 103 is arranged on the door frame 101. The door closer 2 is connected to a lever arrangement 104 via its output shaft 8 (see FIG. 2 ff.). The lever arrangement 104 slides in the slide rail 103.

Furthermore, FIG. 1 shows purely schematically that a door hold-open system 105 can be located in the slide rail 103. A door lock 106 can be located in the door leaf 102.

FIG. 1 also shows a monitoring device 1. As explained in the general part of the description, the monitoring device 1 is designed for a door functional unit; in particular, the door functional unit is a component of the monitoring device 1. The door functional unit can, for example, be the door closer 2, the door hold-open system 105 or the door lock 106. It has also been described that the door functional unit can also be designed as a door drive. Such a door drive is located on the door frame 101, for example. The door functional unit as door closer 2 will be described in more detail below.

As FIG. 1 schematically illustrates, the monitoring device 1 comprises a control arrangement 3 in addition to the door functional unit, here designed as the door closer 2. This control arrangement 3 can be divided into different control units or computing units. This is represented schematically in FIG. 1 by the fact that one part of the control arrangement 3 is located on or in the door closer 2 and another part of the control arrangement 3 is arranged outside the door 100. The different regions of the control arrangement 3 are connected to each other for data exchange, for example in a wireless or wired manner.

FIG. 1 also illustrates that another arrangement 200 can be provided, which is connected to the control arrangement 3 for data exchange. The control arrangement 3 can, for example, output corresponding signals to this other arrangement 200.

FIGS. 2 to 5 illustrate the structure of the door functional unit, here designed as the door closer 2, of the monitoring device 1. Reference will always be made below to all figures, unless otherwise stated in individual cases.

FIGS. 2 to 5 show that the door closer 2 comprises a carrier 5, for example a mounting plate. A housing 6 of the door closer 2 is mounted on this carrier 5. The housing 6 is in particular made of metal. An output shaft 8, referred to as a functional element in the general part of the description, is supported in the housing 6 in a rotatably-movable manner. The output shaft 8 rotates about an axis of rotation 9.

As explained in the general part of the description, an energy accumulator, in particular a spring, is located in the housing 6. When the door is opened, the output shaft 8 is rotated accordingly via the lever arrangement 104, which charges the energy accumulator inside the housing 6. When the door is closed, the energy accumulator in the housing 6 is relieved and rotates the output shaft 8 in the opposite direction.

FIG. 3 shows that the door closer 2 can comprise a battery pack 7, which can be used to supply power to electronic components within the door closer 2 or the entire monitoring device 1.

The door closer 2 also comprises a covering 4. The covering 4 can, for example, be fastened to the carrier 5 and/or the housing 6. The covering 4 covers the housing 6 at least partially, in particular completely.

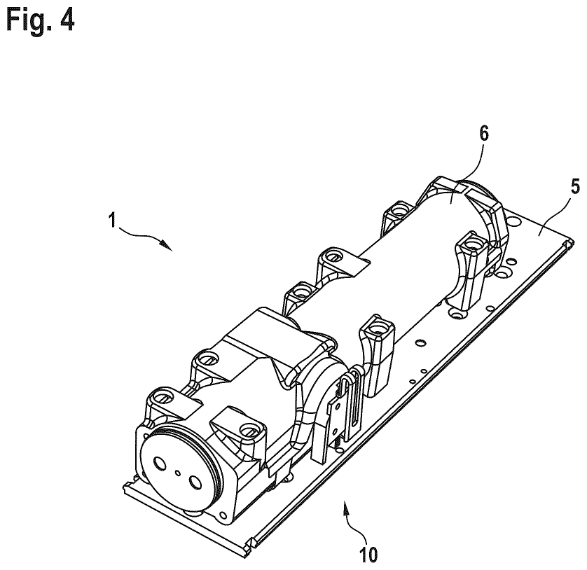

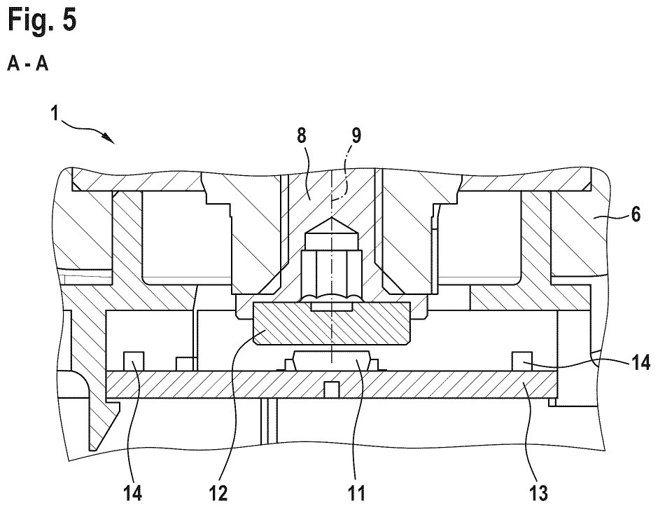

FIG. 4 illustrates that a sensor unit 10 is arranged on the end face of the output shaft 8. The sectional view in FIG. 5 shows the more detailed structure of the sensor unit 10. Accordingly, the sensor unit 10 comprises a first magnetic sensor 11 and an encoder 12. In the exemplary embodiment shown, the encoder 12 is a permanent magnet that is arranged on the end face of the output shaft 8. The first magnetic sensor 11 is at a distance from this encoder 12 and detects the movement of the encoder 12. The axis of rotation 9 intersects both the encoder 12 and the first magnetic sensor 11.

The first magnetic sensor 11 is located on a circuit board 13. Two second magnetic sensors 14 are arranged on this circuit board 13. In the exemplary embodiment shown, FIG. 5 illustrates that not only one second magnetic sensor 14, but for example two second magnetic sensors 14 can be used on different sides of the first magnetic sensor 11.

FIG. 3 illustrates purely schematically that a permanent magnet 15 can be located on the covering 4. This makes it possible, as explained in the general part of the description, to identify removal of the covering 4 by means of one of the magnetic sensors 11, 14.

The exemplary embodiment thus shows the monitoring device 1 with the door closer 2. The sensor unit 10 is designed for arrangement in the door closer 2, with a position of the output shaft 8 being detectable with the first magnetic sensor 11 and the associated encoder 12, and thus by means of the sensor unit 10. The at least one second magnetic sensor 14 is designed and configured to monitor the operation of the first magnetic sensor 11 by detecting an external magnetic field.

In the exemplary embodiment shown, both the sensor unit 10 and the at least one second magnetic sensor 14 are arranged in the door closer 1. The first magnetic sensor 11 and the at least one second magnetic sensor 14 are arranged under the covering 4 and are located, for example, on the carrier 5.

In the exemplary embodiment shown, the at least one second magnetic sensor 14 can be arranged both in the region of influence of the sensor unit 10 and outside this region of influence.

As explained in the general part of the description, the first magnetic sensor 11 and/or the at least one second magnetic sensor 14 can be designed as a Hall sensor, inductive sensor, reed switch or as a magnetic sensor whose function is based on the giant magnetoresistance effect.

The control arrangement 3 shown in the exemplary embodiment is designed to monitor the operation of the first magnetic sensor 11 in particular to do the following: Validate at least one value based on the detected position of the output shaft 8 with the first magnetic sensor 11, with the validation being based on the recorded values of the at least one second magnetic sensor 14; and/or check whether the sensor unit 10 has been manipulated by an external magnetic field, with the check being based on the recorded values of the at least one second magnetic sensor 14. Furthermore, the control arrangement 3 can store the basic state data described in the general part of the description.

The control arrangement 3 shown in the exemplary embodiment is preferably designed to do the following: Store and/or retrieve external magnetic field comparison data sets, categorise the detected external magnetic field based on the external magnetic field comparison data sets into disruptive external magnetic fields and non-disruptive external magnetic fields, with the subsequent validation being based on this categorisation and/or categorise the detected external magnetic field based on the external magnetic field comparison data sets into manipulative external magnetic fields and non-manipulative external magnetic fields, with the subsequent check being based on this categorisation.

Furthermore, the control arrangement 3 shown in the exemplary embodiment is designed for the learning mode, as defined in the general part of the description.

The control arrangement 3 shown in the exemplary embodiment can be designed to do the following: Output a signal to the other arrangement 200, with the signal being based on the result of the validation and/or check; and/or output a message that can be perceived by a person, with the message being based on the result of the validation and/or check; and/or store a value in a memory, with the stored value being based on the result of the validation and/or check.

Furthermore, the control arrangement 3 shown in the exemplary embodiment can be designed to take into account the recorded values of the first magnetic sensor 11 during the validation and/or check, in particular to subtract them at least partially from the recorded values of the at least one second magnetic sensor 14.

1. A monitoring device for a door functional unit, in particular a door closer, door drive, door lock or door hold-open system, the monitoring device comprising:
a sensor unit, designed for arrangement in the door functional unit, having a first magnetic sensor and an associated encoder, wherein the sensor unit is designed and configured to detect a position of a moving functional element of the door functional unit,
and at least one second magnetic sensor, which is designed and configured to detect an external magnetic field to monitor the operation of the first magnetic sensor.

2. The monitoring device according to claim 1, wherein the at least one second magnetic sensor is designed for arrangement in the door functional unit.

3. The monitoring device according to claim 1, comprising the door functional unit,
wherein the sensor unit and/or the at least one second magnetic sensor is/are arranged in the door functional unit;
wherein the door functional unit comprises a covering and/or a carrier, wherein the first magnetic sensor and/or the at least one second magnetic sensor is/are arranged under the covering and/or on the carrier; and
wherein a permanent magnet is arranged on the covering such that a movement of the covering relative to the first magnetic sensor and/or relative to the at least one second magnetic sensor is detectable.

4. The monitoring device according to claim 1, comprising a circuit board, wherein the first magnetic sensor and the at least one second magnetic sensor are arranged on the circuit board.

5. The monitoring device according to claim 1, comprising at least two of the second magnetic sensors arranged on different sides of the first magnetic sensor.

6. The monitoring device according to claim 1, wherein the at least one second magnetic sensor, is/are arranged in a region of influence of the sensor unit; and/or wherein the distance between the encoder and the nearest second magnetic sensor is at most 5 cm.

7. The monitoring device according to claim 1, wherein the at least one second magnetic sensor, is arranged outside a region of influence of the sensor unit; and/or wherein the distance between the encoder and the nearest second magnetic sensor is at least 6 cm.

8. The monitoring device according to claim 1, wherein the first magnetic sensor:
is designed as a Hall sensor,
or is designed as a magnetic sensor whose function is based on the giant magnetoresistance effect,
or is designed as an inductive sensor,
or is designed as a reed switch;
and/or wherein the at least one second magnetic sensor:
is designed as a Hall sensor,
or is designed as a magnetic sensor whose function is based on the giant magnetoresistance effect,
or is designed as an inductive sensor,
or is designed as a reed switch.

9. The monitoring device according to claim 3, wherein the door functional unit is designed as a door closer, wherein the door functional unit comprises:
a housing and an output shaft supported therein as the functional element,
and a mechanical energy accumulator in the housing that drives the output shaft to rotate;
wherein the encoder of the sensor unit is arranged or designed on the output shaft;
wherein the sensor unit is designed to detect an actual angle of rotation of the output shaft.

10. The monitoring device according to claim 9, wherein the first magnetic sensor is positioned on the end face of the output shaft; wherein the axis of rotation of the output shaft intersects the first magnetic sensor and/or the encoder.

11. The monitoring device according to claim 1, comprising a control arrangement which is designed to do the following to monitor the operation of the first magnetic sensor:
validate at least one value based on the detected position of the functional element with the first magnetic sensor, wherein the validation is based on the recorded values of the at least one second magnetic sensor,
and/or check whether the sensor unit has been manipulated by an external magnetic field, wherein the check is based on the recorded values of the at least one second magnetic sensor,
and preferably store basic state data based on signals of the first magnetic sensor and/or the at least one second magnetic sensor without an external magnetic field.

12. The monitoring device according to claim 11,
wherein the control arrangement is designed to do the following:
store and/or retrieve external magnetic field comparison data sets,
categorise the detected external magnetic field based on the external magnetic field comparison data sets into disruptive external magnetic fields and non-disruptive external magnetic fields, wherein the subsequent validation is based on the categorisation into disruptive/non-disruptive external magnetic fields,
and/or categorise the detected external magnetic field based on the external magnetic field comparison data sets into manipulative external magnetic fields and non-manipulative external magnetic fields, wherein the subsequent check is based on the categorisation into manipulative/non-manipulative external magnetic fields.

13. The monitoring device according to claim 12, wherein the control arrangement is designed to do the following in a learning mode:
detect an external magnetic field by means of the at least one second magnetic sensor to generate external magnetic field comparison data sets,
retrieve a categorisation of the detected external magnetic field into disruptive/non-disruptive external magnetic fields and/or into manipulative/non-manipulative external magnetic fields,
and save the external magnetic field comparison data set with associated categorisation.

14. The monitoring device according to claim 11, wherein the control arrangement is designed to do the following:
output a signal to another arrangement, wherein the signal is based on the result of the validation and/or on the result of the check,
and/or output a message that can be perceived by a person, wherein the message is based on the result of the validation and/or on the result of the check,
and/or store a value in a memory, wherein the stored value is based on the result of the validation and/or on the result of the check.

15. The monitoring device according to claim 11, wherein the first magnetic sensor and the at least one second magnetic sensor are arranged to detect the encoder, wherein the control arrangement is designed to take into account the recorded values of the first magnetic sensor during the validation and/or check, in particular to subtract them at least partially from the recorded values of the at least one second magnetic sensor.
